(19) United States
(12) Patent Application Publication
(10) Pub. No.: US 2019/0369562 A1
(43) Pub. Date: Dec. 5, 2019

(54) WATCH GLASS WITH LUMINESCENT ELEMENT

(71) Applicant: REALIZATION DESAL AG, OBERWIL (CH)

(72) Inventor: MICHAEL BONKE, OBERWIL (CH)

(21) Appl. No.: 16/481,511

(22) PCT Filed: Nov. 7, 2017
(86) PCT No.: PCT/EP2017/078427

§ 371 Date: Jul. 29, 2019

(30) Foreign Application Priority Data
Feb. 2, 2017 (DE) 10 2017 201 676.0

(51) Int. Cl. G04B 19/30; G04B 39/00

(52) U.S. Cl. CPC G04B 19/30; G04B 39/00

(57) ABSTRACT

The invention relates to a watch glass comprising a cover glass, a support glass connected with the cover glass for forming a glass unit and a luminescent element introduced into the glass unit. Furthermore, the invention relates to a watch comprising such a watch glass.

The invention relates to a watch glass with luminescent elements.

Dials with self-luminous fluorescent light points are sufficiently known. As well, related watch hands filled up with self-luminous fluorescent substance are previously known. The light points on the dial and the self-luminous hands aim for that the wearer of the watch is able to read the time at his/her watch even at night without any additional light.

However, the previous methods of a self-luminous display of digits and hands by means of self-luminous substances in, or besides, the digits and on, or in, the hands have an essential design disadvantage. The hands have to be correspondingly thick or wide for being capable of accommodating the luminous substance. Also, the digits of the watch have to share the space with the light points, or the complete digits have to be wide such that they may be filled up with luminous substance.

As a result, a filigree, artfully configured watch design always collides with the space requirements of the luminous substance and, thus, is actually made impossible.

It is the object of the invention to propose a watch glass with which the complete used luminescent luminous substance can be reduced regarding space requirements without impairing the readability of the time in the dark, wherein also an esthetically appealing appearance of the watch is possible.

This object is achieved by the features of claim 1. The dependent claims show preferred further developments of the invention.

Particularly, the object is achieved by means of a watch glass comprising a cover glass, a support glass connected with the cover glass for forming a glass unit and a luminescent element introduced into the glass unit. The present invention transfers the placement of the luminous substance configured in form of a luminescent element into the watch glass. Thus, on the one hand, it is achieved that by using the watch glass in a watch the self-luminous substance emits its light rays to the viewer directly and therefore makes a time scale clearly visible even in the dark or rather at night. On the other hand, the luminous substance also emits its light in the opposite direction towards the interior space of the watch where the dial and the hands are located. Thus, the luminescent element illuminates both the hands and the dial which are arranged beneath the watch glass. As a result, the hands being devoid of luminous substance may freely be configured. Furthermore, also other elements such as the numbers of the dial etc. may be selected without any design trade-offs and may have no luminous substance. Hence, it is possible to reduce the total amount of luminous substance where the luminous substance interferes, namely on the dial and the hand(s). There, its amount is reduced to zero. Additionally, by using a plurality of luminescent elements an improved pattern in view of the distribution of the elements in the watch glass can be achieved, in turn resulting in an improved appearance of the watch glass or rather the watch.

The great advantage of the invention is that the luminescent element not only illuminates back to the viewer and is thus seen itself. In fact, the luminescent element itself becomes an illuminating means of the whole watch. Hence, the luminescent element is not only to be “seen”, but also to illuminate. The dial and the hands don't shine, they are illuminated like during the day or with external illumination. This occurs due to the fact that the luminescent element is integrated into the watch glass above the interior space of the dial and the hands.

Within the invention, the cover glass is to be considered as a first glass and the support glass as a second glass. The cover glass particularly corresponds to the glass facing towards the viewer or rather facing away from a bottom of a watch housing. The support glass particularly corresponds to the glass facing away from the viewer or rather facing towards the bottom of the watch housing. “Luminescent” means that the element does not add any energy supplied from the outside, for example by the sun, to its thermal energy completely or partially, but is put into an excited state by the absorbed energy and emits light. If no activation process occurs between the absorption of the energy and the emission, it is termed fluorescence. If an excited intermediate state is able to “store” the energy for some time, then it is termed phosphorescence. Furthermore, a very short afterglow, as an immediate consequence and side effect, is termed fluorescence. On the other hand, the term phosphorescence means a longer lasting afterglow after the excitation. In other words, the term “luminescent” or rather “luminescence” functions as a general term and includes the subtopics of “fluorescence” and “phosphorescence”.

Preferably, in the watch glass at least one recess is provided in which the luminescent element is arranged, wherein the recess is formed in the cover glass and/or in the support glass. By providing a recess into which the luminescent element is introduced, the positioning of the luminescent element is performed in a controlled manner such that a final positon of the element in the finished watch glass can be ensured easily.

In particular, it is preferred to form the recess completely in the support glass. Hence, the luminescent element is located closer to a dial and the hands of a watch comprising the described watch glass. Thereby, the intensity of the illumination of a region of the dial illuminated by the luminescent element is enhanced. Alternatively, the recess may preferably be formed in the support glass. Thus, a larger region of the dial may be illuminated by the luminescent element. An additional advantage of a recess with a luminescent substance in the support glass is that the cover glass may then be devoid of recesses. This facilitates the use of sapphire glass as a cover glass which is considerably harder to be provided with a recess than the softer mineral glass of the support glass. The use of sapphire glass as a cover glass or a closure of the watch glass to the outside is appropriate as the scratch-resistant sapphire glass is preferably be applied to high-quality watches.

Further, the luminescent element is preferably arranged in the center of the glass unit, consisting of the support glass and the cover glass, in the direction of the thickness of the glass unit. Hence, the luminescent element is preferably positioned in the center of the glass unit in a direction perpendicular to the glass unit or rather to the larger area of the glass unit.

Preferably, the luminescent element may be configured as a gemstone, in particular a diamond, and/or an indicator and/or a time marking element, wherein the gemstone, the indicator and the time marking element have luminescent characteristics.

In an advantageous manner, the complete recess is filled up by the luminescent element. Substantially no air is within the recess. Thus, a light refraction otherwise occurring at the boundary between air and the luminescent element can be avoided. This results in the fact that no light gets lost or rather is dispersed due to such a light refraction.

According to an alternative preferred configuration, the luminescent element only partially occupies the recess. This facilitates the introduction of the luminescent element into the recess.

This is particularly advantageous if a luminescent element configured as a fluorescent gemstone, in particular a fluorescent diamond, for example in brilliant cut, is provided. In that case the luminescent element doesn't occupy the complete recess.

In case of using, for example, fluorescent gemstones, especially natural fluorescent diamonds, at least one black light LED illuminating the fluorescent diamonds from below and making them fluoresce may preferably be attached within the interior space of the watch. However, it is also conceivable that a black light LED is provided if luminescent elements other than fluorescent gemstones are used.

In order to connect the cover glass and the support glass with each other, an intermediate layer is provided between the cover glass and the support glass. The intermediate layer preferably includes a self-crosslinking film, in particular a polymer film and/or an adhesion film, a silicone layer and/or a, particularly UV-curable, adhesive.

Thereby, the luminescent element may preferably be arranged in the intermediate layer. In particular, the luminescent element is completely positioned in the intermediate layer. In that case a recess in the cover glass and/or in the support glass can be dispensed with. A thickness of the luminescent element is preferably smaller than a thickness of the intermediate layer.

Furthermore, a plurality of luminescent elements is provided in the watch glass, wherein the elements are arranged in the glass unit in circumferential direction of the glass unit. In particular, the luminescent elements are located on a circle in the glass unit.

The recess and/or the luminescent element are/is preferably configured and/or arranged such that light may emit from at least 50% of an area of the bottom side of the support glass when the luminescent element is shining.

Thereby, at first, the light originating from the luminescence emits upwards. Daylight or an illuminating means exciting the luminescence will here excite the upper layers of the luminous substance at first and thereafter they will increasingly reflect towards the viewer's eye. Then, in that case the luminous substance also transfers energy downwards, also in form of light which thereafter excites the deeper layers of the luminous substance.

Further, it should be noted that the term “luminescent element” with the phrasing “light emits from X % of an area” is to be understood as also including a plurality of luminescent elements. In other words, the foregoing statement concerning the percentage also applies if a plurality of luminescent elements is provided.

Another advantage of positioning the luminous substance (luminescent elements) in the watch glass is that the light yield of just this substance is quite clearly optimized. If the luminous substance is attached at the bottom of the interior space of the watch glass, i.e. on the dial or on the hands, then only that light takes effect which emits upwards, i.e. towards the viewer of the watch. That light emitting in the opposite direction, i.e. towards the dial or rather towards the hands on which the luminous substance is applied, gets lost to the viewer. Since in the present invention all the material surrounding the luminescent element or rather the luminescent elements is transparent, an almost 100% yield of the emitting light is achieved. Thus, the effect of the luminous substance (no matter whether a chemical substance or a fluorescent gemstone, for example) can significantly be optimized.

The invention further relates to a watch comprising a watch glass described above.

Further details, advantages and features of the present invention can be gathered from the following description of exemplary embodiments with reference to the drawing, in which identical, or rather functionally identical, parts are each denoted by the identical reference sign. In the drawing:

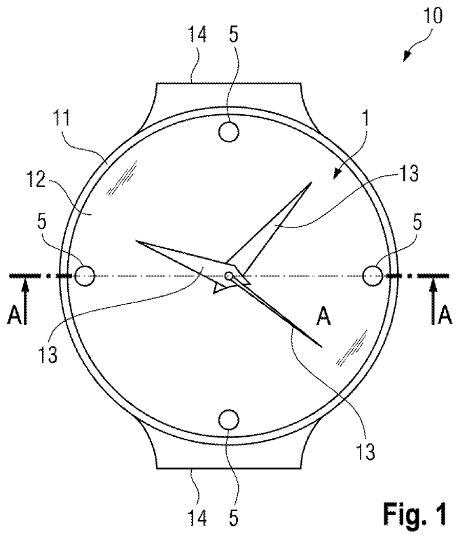

FIG. 1 shows a schematic plan view of a watch comprising a watch glass according to a first exemplary embodiment of the present invention,

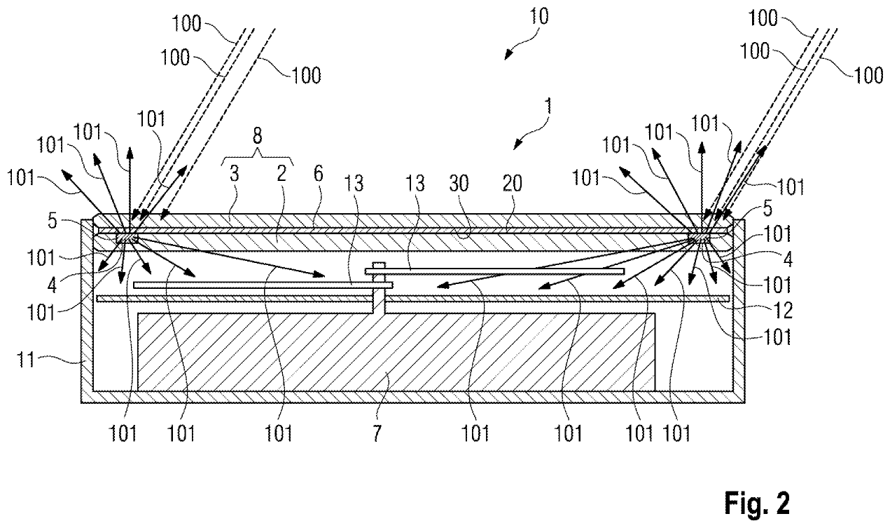

FIG. 2 shows a schematic sectional view of the watch glass of FIG. 1, and

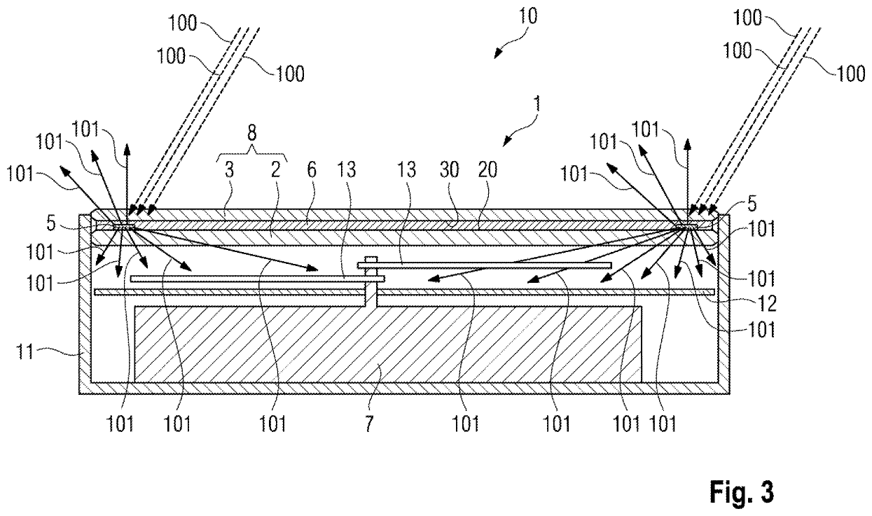

FIG. 3 shows a schematic sectional view of a watch glass according to a second exemplary embodiment of the present invention.

Subsequently, a watch glass 1 according to a first exemplary embodiment of the present invention is described in detail with reference to FIGS. 1 and 2.

FIG. 1 shows a watch 10 in form of a wristwatch having a housing 11 and a watch glass 1 according to the invention arranged in the housing 11. The housing 11 as well as the watch glass 1 are formed in circular shape, but may have any other shape such as, e.g., of a rectangle, a polygon etc. The watch 10 further comprises a dial 12 configured as a gold sheet, for example, as well as three hands 13 for indicating the hours, minutes and seconds and two connectors for a wristband 14. Furthermore, the watch 10 includes a clockwork 7 for operating the hands 13. Obviously, watches not having 3, but only 2 hands are also conceivable.

In addition, the watch glass 1 is provided with luminescent elements 5. Here, in particular, four luminescent elements 5 are arranged within the watch glass 1 with a constant radius in circumferential direction equally spaced to each other. However, the position as well as the number of the luminescent elements 5 may arbitrarily be selected depending on the watch design. Thus, for example, it is also possible to integrate either only one luminescent element or also two or twelve luminescent elements into the watch glass 1.

FIG. 2 is a simplified schematic view of a section A-A of the watch glass 1 of FIG. 1. The watch glass 1 comprises a support glass 2 and a cover glass 3. The support glass 2 and the cover glass 3 are preferably be made of different glass types. In particular, the support glass 2 is a mineral glass, and the cover glass 3 is a sapphire glass. Other glass types can also be used. Hence, for example, the support glass 2 can be formed of sapphire glass or a polymer product, e.g. perspex, and/or the cover glass 3 can be formed of mineral glass or perspex. Within the scope of the invention, it is possible to combine different or identical glass types.

Recesses 4 functioning to accommodate the luminescent elements 5 are formed in the support glass 2. In FIG. 2, two such recesses 4 are visible. Preferably, the recesses 4 are exclusively formed in the support glass 2.

It is preferred that in each recess 4 the corresponding luminescent element 5 is completely arranged. This means that the luminescent element 5 preferably fills up the related recess 4 completely.

Alternatively, it is possible that the recesses 4 are not completely, i.e. only partially, filled up by the luminescent elements 5. In particular, this is the case if fluorescent gemstones, especially preferred fluorescent diamonds, for example in brilliant cut, are used as the luminescent elements 5.

The cover glass 3 and the support glass 2 are particularly formed in circular shape and have the same diameter. The glasses 2, 3 differ in their thicknesses, wherein the cover glass 3 is preferably formed thinner. But it is also possible that the two glasses 2, 3 have the same thickness. Furthermore, an inner surface 20 of the support glass 2 and an inner surface 30 of the cover glass 3 are formed in a planar manner at the contact point of the two glasses 2, 3. According to an alternative configuration, however, the inner surfaces 20, 30 may also be equally and complementarily curved.

The cover glass 3 and the support glass 2 are connected with each other through a connecting intermediate layer 6 (connection layer). The intermediate layer 6 may particularly be formed as an adhesive film, a laminating film, an adhesive or any other connecting substance. The intermediate layer 6 is arranged between the cover glass 3 and the support glass 2. Thus a seamless air-tight joint results between the cover glass 3 and the support glass 2.

Advantageously, the luminescent elements 5 may store light (arrows 100), especially sunlight, in case of being illuminated and emit it (arrows 101) again in the dark.

For manufacturing the watch glass 1, at first, the cover glass 3, the support glass 2 and the luminescent elements 5 are provided. The recesses 4 for receiving the luminescent elements 5 are introduced into the support glass 2. Thereafter the luminescent elements 5 are inserted into the recesses 4.

The intermediate layer 6 is applied to the support glass 2. As already described, the intermediate layer 6 may be a self-crosslinking polymer film, a thin silicone layer, an UV-curing adhesive or any other connecting material. After applying the intermediate layer 6 the cover glass 3 is applied to the intermediate layer 6. In doing so, it is preferred that the intermediate layer 6 is heated under vacuum and under pressure from above and below simultaneously. In this way, the support glass 2 and the cover glass 3 are connected with each other such that the luminescent elements 5 are fixedly included between the two glasses 2, 3 and that the complete structure becomes a strong glass unit 8.

The second exemplary embodiment of FIG. 3 basically differs from the first exemplary embodiment of FIGS. 1 and 2 in that no recesses are formed in the watch glass 1. Instead the luminescent elements 5 are preferably embedded in the intermediate layer 6. In particular, the luminescent elements 5 are located on the inner side 20 of the support glass 2.

The method for manufacturing the watch glass 1 according to the second exemplary embodiment corresponds to the method for manufacturing the watch glass 1 according to the first exemplary embodiment apart from the steps of introducing recesses into the support glass 2 and inserting the luminescent elements 5 into the recesses.

Here, after providing the support glass and the cover glass, the luminescent elements 5 are put onto the support glass 2. Then the intermediate layer 6 is applied to the support glass and the luminescent elements 5, respectively.

The further steps for connecting the support glass 2 with the cover glass 3 correspond to those of the first exemplary embodiment.

It should be noted that in the above described embodiments of the invention the watch glass 1 comprises two glasses (cover glass and support glass). It is, however, possible that the watch glass 1 comprises several glasses, wherein successively following glasses are connected with each other, especially by means of an intermediate layer.

Alongside the written description of the invention documented above, the disclosure of the invention is supplemented by reference hereby being made explicitly to the illustration thereof in FIGS. 1 to 3.

### LIST OF REFERENCE SIGNS

1 Watch glass
2 Support glass
3 Cover glass
4 Recess
5 Luminescent element
6 Intermediate layer
7 Clockwork
8 Glass unit
10 Watch
11 Housing
12 Dial
13 Hands
14 Connector for a wristband
20 Inner side of the support glass (side of the support glass facing towards the cover glass)
30 Inner side of the cover glass (side of the cover glass facing towards the support glass)
100 Received light
101 Emitted light

1. A watch glass, comprising:
a cover glass;
a support glass connected with the cover glass for forming a glass unit; and
a luminescent element introduced into the glass unit.

2. The watch glass according to claim 1, further comprising at least one recess in which the luminescent element is arranged, wherein the recess is formed in the cover glass and/or in the support glass.

3. The watch glass according to claim 1, wherein the luminescent element is arranged in the center of the glass unit, consisting of the support glass and the cover glass, in the direction of the thickness of the glass unit.

4. The watch glass according to claim 1, wherein the luminescent element is formed as a gemstone, and/or an indicator and/or a time marking element having luminescent characteristics.

5. The watch glass according to claim 2, wherein the recess is filled completely by the luminescent element.

6. The watch glass according to claim 1, further comprising an intermediate layer by means of which the cover glass and the support glass are connected with each other is arranged between the cover glass and the support glass.

7. The watch glass according to claim 6, wherein the luminescent element is arranged in the intermediate layer.

8. The watch glass according to claim 1, wherein a plurality of luminescent elements are provided, wherein the plurality of luminescent elements are arranged in the glass unit in circumferential direction of the glass unit.

9. The watch glass according to claim 2, wherein the recess and/or the luminescent element are/is configured and/or arranged such that light may emit from at least 50% of the area of a bottom side of the support glass when the luminescent element is shining.

10. A watch, comprising a watch glass that comprises:
a cover glass;
a support glass connected with the cover glass for forming a glass unit; and
a luminescent element introduced into the glass unit.

11. The watch according to claim 10, wherein the watch glass further comprises at least one recess in which the luminescent element is arranged, wherein the recess is formed in the cover glass and/or in the support glass.

12. The watch according to claim 10, wherein the luminescent element is arranged in the center of the glass unit, consisting of the support glass and the cover glass, in the direction of the thickness of the glass unit.

13. The watch according to claim 10, wherein the luminescent element is formed as a gemstone, and/or an indicator and/or a time marking element having luminescent characteristics.

14. The watch according to claim 11, wherein the recess is filled completely by the luminescent element.

15. The watch according to claim 10, wherein the watch glass further comprises an intermediate layer by means of which the cover glass and the support glass are connected with each other is arranged between the cover glass and the support glass.

16. The watch according to claim 15, wherein the luminescent element is arranged in the intermediate layer.

17. The watch according to claim 10, wherein a plurality of luminescent elements are provided, wherein the plurality of luminescent elements are arranged in the glass unit in circumferential direction of the glass unit.

18. The watch according to claim 11, wherein the recess and/or the luminescent element are/is configured and/or arranged such that light may emit from at least 50% of the area of a bottom side of the support glass when the luminescent element is shining.

19. The watch according to claim 13, wherein the gemstone is a diamond.

20. The watch glass according to claim 4, wherein the gemstone is a diamond.
